(19) United States
(12) Patent Application Publication
(10) Pub. No.: US 2013/0026982 A1
(43) Pub. Date: Jan. 31, 2013

(54) WIRELESS BATTERY CHARGING DEVICE, METHOD AND SYSTEM

(71) Applicant: Perry Rothenbaum, Chicago, IL (US)

(72) Inventor: Perry Rothenbaum, Chicago, IL (US)

(21) Appl. No.: 13/194,150

(22) Filed: Jul. 29, 2011

(51) Int. Cl. H02J 7/00

(52) U.S. Cl. 320/108; 320/137

(57) ABSTRACT

A battery charging device, method and system are disclosed for wirelessly charging a battery. A transmitter can transmit an RF wireless power signal to a battery charging device, and a receiver within the battery charging device can receive the RF wireless power signal. The battery charging device can thereafter transfer the received RF wireless power signal to a battery receiving portion to charge the battery. In an embodiment, the RF wireless power signal is transferred at a frequency of about 13.56 MHz to overcome wave shadowing. A battery recharging feedback control circuit can optionally be applied in combination with the battery charging device and can monitor a power quantity of the RF wireless power signal.

### FIELD OF THE INVENTION

The present invention relates to charging batteries with wireless power signals. In particular, the present invention relates to a device, method and system that wirelessly charges batteries with radio frequency (RF) signals.

### BACKGROUND OF THE INVENTION

Batteries have become an increasingly popular energy source for portable electronic devices, such as mobile phones, lap top computers, and digital cameras. Depending on the configuration, a single battery can power an electronic device for several hours without requiring the device to be plugged in to a wall receptacle or other power source. However, the power supplied by the battery is temporary by its very nature due to the electrochemical reaction that produces the electrical current. As a result, consumers are sometimes forced to throw away a battery after only a few uses.

Efforts have been made to produce rechargeable batteries and battery recharging systems in order to avoid the waste and expense that conventional batteries offer. Current recharging systems include a cradle that holds the battery in place and that applies electrical energy to the battery in a manner that causes electron flow to reverse relative to the direction of electron flow during discharge. Power is therefore restored to the battery in the opposite manner that power was discharged from the battery. However, the conventional recharging systems require a contact-based recharging method, where the user must disassemble the batteries from the relevant device or from their container and insert the batteries into the cradle one by one.

Wireless or “contactless” battery charging has achieved some developments in recent years due to the shortcomings of conventional contact-based battery charging systems. These contactless systems can be found in, for example, electronic toothbrushes, where the battery is recharged when the toothbrush is inserted into the cradle that holds it upright. Although there is contact between the plastic of the toothbrush and cradle, the battery itself does not contact the metallic recharging mechanism inside the cradle, and so this system is still considered “contactless.” A wireless consortium has even been established to standardize contactless recharging of batteries in the conventional fashion. However, conventional contactless recharging systems use magnetic fields to recharge the batteries, e.g. by using an induction coil provided within the cradle. Magnetic field recharging is incapable of charging a battery at larger distances, and is only adapted for close-range charging of a single, or very few, devices.

Lithium-ion (Li-ion) batteries are a powerful and popular type of battery but include inherent safety drawbacks that require the batteries to be shipped partially discharged based on government regulations. Like all batteries, Li-ion batteries slowly discharge even when not in use, and if discharged below a certain threshold, will be permanently damaged. Electronics containing Li-ion batteries are thus susceptible to being purchased by a consumer with a battery that was shipped partially discharged (due to safety regulations), and where the battery is further discharged in a warehouse or on the shelf of the retailer while waiting to be purchased.

Several attempts have been made to produce a sufficient long-range charging method using technology other than the conventional short-range magnetic recharging. For example, U.S. Pat. No. 7,288,918 to DiStefano uses longer-range radio frequency (RF) signals to transmit a power signal to a battery recharging circuit. DiStefano discloses a general block diagram configuration in which a power charger is operatively connected to a battery and receives a carrier frequency signal from a power transmitter to recharge the battery. The DiStefano system requires means for generating and transmitting a modulated signal with the modulation being one of frequency modulation, amplitude modulation and phase modulation. The relatively complex system of DiStefano further requires a power receiving circuit and an energy storing circuit for storing energy received from the power receiving circuit until sufficient energy is stored for transfer to a power charging circuit. The RF power signal is transmitted in a predetermined power and carrier frequency, and does not vary based on what is needed to charge the battery. Further, depending on the nature of the signal transmitted, power has to be stored and monitored/measured or sufficiency until such time as it is sufficient to be transferred to a charging circuit to charge a battery. DiStefano does not disclose any specific frequencies for the RF power signal, but only discusses the general idea of RF battery charging.

### SUMMARY OF THE INVENTION

The present invention provides a non-complex system and method for directly charging batteries standing alone or within several devices at longer distances, and for example, for long-range recharging of Li-ion batteries for storage/shipment and use with electronic devices. The present disclosure describes a device, method and system for recharging a battery where multiple batteries can be charged at the same time. A contactless battery charging technology is disclosed where RF waves are transmitted to one or more batteries in a specific frequency, and can optionally be used in conjunction with a feedback system that varies the amount of power transmitted via the RF signal.

In particular, the present disclosure describes a simple, inexpensive system and method for battery recharging, including a transmitter that transmits a radio frequency (RF) wireless power signal at one of the Radio Frequency Identification (RFID) frequencies, including one of a frequency of about 125K Hz, about 13.56 MHz, or about 915 MHz (individually referred to herein as “an RFID Frequency”). The system and method of the disclosure further includes an RF transmitter that transmits a wireless RF power signal or signals and an RF signal receiving device and a battery recharging receiving device that is connected to the positive and negative terminals of a cell or battery to electrically transfer power to the battery to charge the battery. With the RF receiver, battery charging receiver, and battery receiving portion implemented as part of a battery “pack,” each battery has its own, low cost, receiver adapted to receive the RF wireless power signal and each battery pack is adapted to electrically transfer the received power to its respective battery to charge the battery within range of the RF wireless power signal.

Also disclosed is a battery charging method including the steps of receiving an RF wireless signal transmitted at an RFID frequency, conveying the RF wireless power signal to a battery receiving portion, and charging a battery positioned within the battery receiving portion with the RF wireless signal. With the receiver and battery receiving portion implemented as part of a battery “pack,” each battery is provided with its own, low cost, receiver adapted to receive the RF wireless power signal and each battery pack is configured to electrically communicate power to the respective battery to charge the battery within range of the RF wireless power signal.

In addition, the present application discloses a battery charging feedback system including a main transceiver adapted to transmit an RF wireless power signal, the main transceiver further including a power adjusting circuit adapted to adjust a power quantity of an RF wireless power signal to be transmitted, and a secondary transceiver adapted to receive the RF wireless power signal and determine the power quantity of the RF wireless power signal, and transmit information indicating the determined power quantity to the main transceiver.

The present disclosure avoids the complicated modulation schemes of known systems, and provides a simple and inexpensive charging system for charging batteries/packs in transit or as they sit on a shelf waiting to be sold or deployed in an electronic device. The system and method according to the invention may be transmitting constantly at a constant, high power to charge batteries in storage or with a feedback mechanism it may be monitoring and regulating transmission as a function of external considerations such as battery charge state or storage facility considerations including time of day, presence and proximity of humans in the facility or electrical demand resource management considerations.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages should be readily understood and appreciated.

The detailed description particularly refers to the accompanying figures in which:

FIG. 1 is a block diagram of one embodiment of the present invention.

FIG. 2 is a general schematic diagram of the battery charging device.

FIG. 3 is a more detailed schematic circuit diagram of the battery charging device.

FIG. 4 is a schematic diagram of a battery charging feedback system.

FIG. 5 is a flowchart illustrating one embodiment of the battery charging system with a feedback mechanism.

FIG. 6 is a flowchart illustrating a second embodiment of the feedback mechanism of the battery charging system.

### DETAILED DESCRIPTION

While this invention is applicable to embodiments in many different forms, there is shown in the drawings and will herein be described in detail an illustrative embodiment of the invention with the understanding that the present disclosure is to be considered as an exemplification of the principles of the invention and is not intended to limit the broad aspect of the invention to embodiments illustrated.

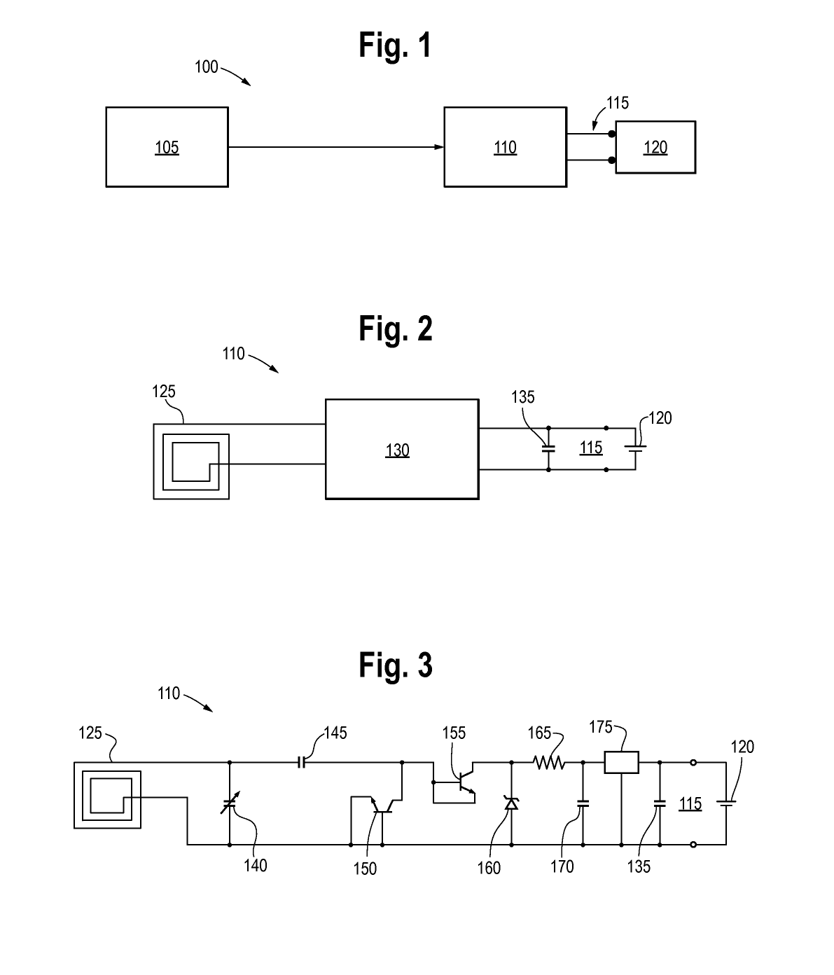

FIG. 1 illustrates a general block diagram of the battery charging system 100 according to the present application. As shown, the battery charging system 100 includes a transmitter 105 that is adapted to transmit an RF wireless power signal to a battery charging device 110. A battery receiving portion 115 is in functional communication with the battery charging device 110 and is adapted to hold a battery 120 and apply charge to the battery 120.

The transmitter 105 can be any device or combination of devices that is/are capable of transmitting an RF wireless power signal to the receiver 110. The transmitter 105 can also be a transceiver capable of receiving wireless communication from the battery charging device 110. In one embodiment, the transmitter 105 transmits the RF wireless power signal at one of the Radio Frequency Identification (RFID) frequencies, including one of a frequency of about 125K Hz, about 13.56 MHz, or about 915 MHz (individually referred to herein as “an RFID Frequency”). In a preferred implementation, the transmitter transmits at approximately 13.56 MHz, the same frequency as many currently implemented radio frequency identification (RFID) signals. The inventor of the present application has determined that the 13.56 MHz transmission frequency allows for greater power levels to be transmitted and at greater distances between the transmitter 105 and the battery charging device 110. In addition, it was determined that the 13.56 MHz transmission frequency is more forgiving to so-called “wave shadowing,” i.e. where a front battery will “shadow” the signal from a rear battery. It was discovered that 13.56 MHz waves bend around the front battery and permit greater coverage of the RF charging system.

The battery charging device 110 can be a combination of electrical components that are capable of receiving the RF wireless power signal transmitted by the transmitter 105, and applying the received RF signal to the battery 120 to charge the battery 120. In one embodiment, the battery charging device 110 is an electronic circuit implemented as part of a battery pack, as discussed below in more detail with reference to FIGS. 2 and 3.

The battery receiving portion 115 can be any of various structures capable of holding or interacting with a battery, in the case of a battery pack containing functionality in addition to the basic battery function, and applying charge to the battery. For example, the battery receiving portion 115 can be a cradle, container, two-pronged assembly, or any other structure that can electrically connect the battery charging device 110 to the battery 120. In a preferred embodiment, the battery receiving portion 115 includes a positive and negative terminal as part of the battery pack to facilitate the flow of electrons into the battery 120.

FIG. 2 illustrates a more detailed configuration of the battery charging device 110. As shown, the battery charging device includes a receiver 125 coupled to a rectifier circuit 130, which is in functional communication with a battery charging capacitor 135. As discussed above, a battery 120 is coupled to the battery charging device 110 via a battery receiving portion 115. In a battery pack implementation, the battery charging device is configured as miniature components in the pack, so that the battery and battery charging device are effectively a fully integrated, unitary entity.

The receiver 125 can be any device that is capable of receiving an RF wireless power signal. In one embodiment, the receiver 125 is an antenna, such as a tag antenna, that is coupled to the rectifier circuit 130 and that is capable of receiving the signal transmitted from the transmitter 105. The receiver 125 is connected to the rectifier circuit 130 so that the received alternating current (AC) signal can be converted to a direct current (DC) signal, and optionally transmitted to the battery charging capacitor 135. Once received by the battery charging capacitor 135, charge can by transmitted to the battery 120 when the stored charge of the battery charging capacitor 135 overcomes the electrostatic potential of the battery charging capacitor 135 to thereby allow current to flow into the battery 120 connected to the battery receiving portion 115.

FIG. 3 illustrates a more detailed schematic circuit diagram of the battery charging device 110 according to the present application. As shown, the battery charging device 110 includes a receiver 125 connected in parallel to a first capacitor 140, which can be an adjustable capacitor. The RF power signal received by the receiver 125 can be transmitted through the first capacitor 140 and into a circuit that includes a second capacitor 145, a first transistor 150 and a second transistor 155. Connected in parallel to the antenna 125 is a Zener diode 160 that protects the overall circuitry if the transmitted voltage is above a predetermined threshold, for example, 14V. The battery charging device 110 can further include a resistor 165 and a third capacitor 170, and prior to the power signal reaching the battery charging capacitor 135, a voltage regulator 175 can be included to manage the voltage that is eventually supplied to the battery 120.

As discussed above, the Zener diode 160 protects the overall circuitry of the battery charging device 110. Optionally, the Zener diode 160 can be omitted from the battery charging device 110 and at least one of the first transistor 150 or the second transistor 155 can maintain a higher breakdown voltage. The circuit as described, or alternatives thereto with substantially similar functionality, can be implemented in a very small scale Application Specific Integrated Circuit (ASIC) or semiconductor die. The receiver die can be attached to the tag antenna significantly reducing package size and cost.

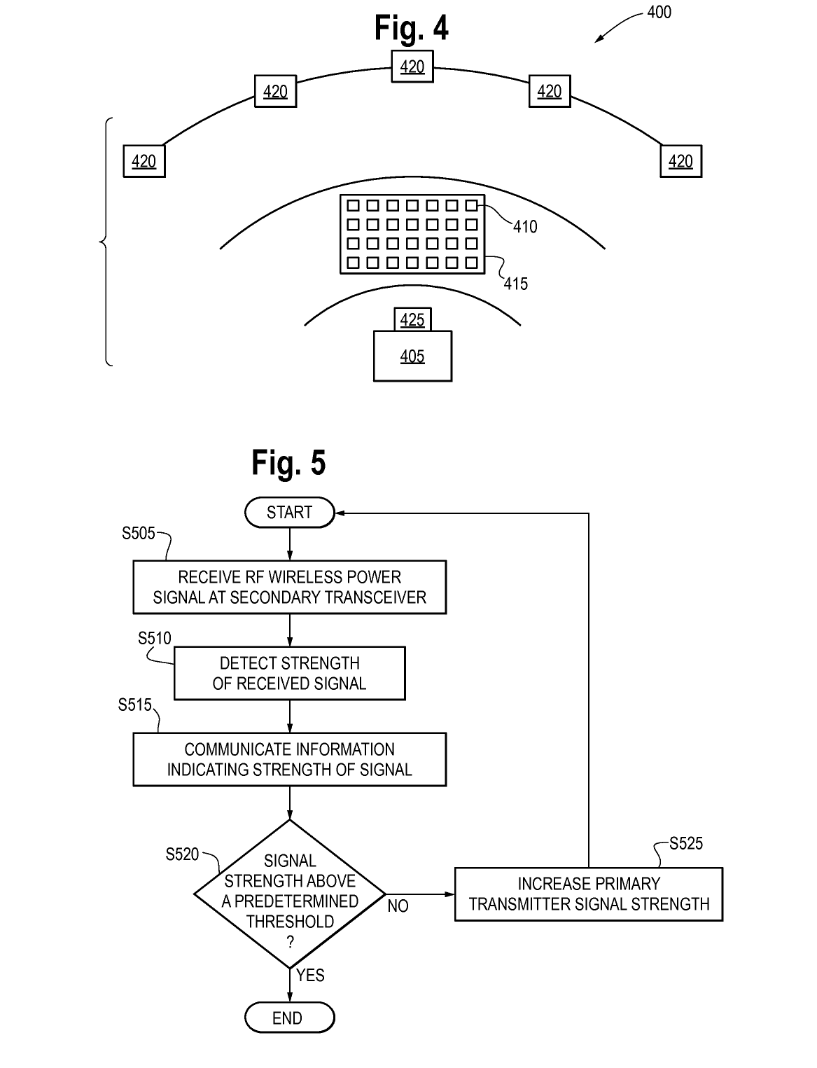

FIG. 4 illustrates an optional battery charging feedback system 400 according to the present application. The feedback system 400 works in conjunction with a main transceiver 405 to wirelessly power one or more batteries 410 positioned within a battery holder 415. In addition, one or more secondary transceivers 420 are provided at the far ends of the generated field of signals provided by the main transceiver 405. A power adjusting circuit 425 can be positioned in functional communication with the main transceiver 405 and can be adapted to increase or decrease the power of the RF wireless signal transmitted by the main transceiver 405. The battery holder 415 can be any device or structure that is capable of holding one or more batteries to allow wireless RF charging of the batteries. In an embodiment, the battery holder 415 includes a plurality of openings that are configured to receive a battery 410 in a fashion that spaces apart the batteries 410 approximately one inch from one another from the back of one battery to the front of the battery behind it. The present inventor discovered that vertically spacing the batteries 410 at least approximately one inch apart from one another helped avoid wave shadowing and allowed all of the batteries 410 to be more sufficiently charged. Positioning the batteries 410 side by side was permissible, so long as the vertical spacing of the batteries 410 was at least approximately one inch so as to space the receivers 125 of the battery charging device 110 connected to the batteries 410. In this embodiment, the cells 410 can be coupled to or positioned directly behind the battery charging device 110 to achieve the preferred positional arrangement. In implementing the invention as described in the context of battery shipping and storage, the battery holder 415 may be a dedicated package/carton for shipping a plurality of batteries.

In the feedback system 400, the secondary transceivers 420 can measure or sense the RF signal generated by the main transceiver 405 and communicate with the main transceiver 405 and/or the power adjusting circuit 425 to change the power transmitted via the RF wireless power signal. The secondary transceivers 420 can be self powered by, for example, batteries of their own or a simple wall socket power source, or can be powered by the RF wireless power signal and contain a battery charging device 110 similar to that discussed above. Alternatively, the secondary transceivers 420 need not have a dedicated battery charging device 110, but can receive and process the RF power signal without the use of a battery or specific charging circuit.

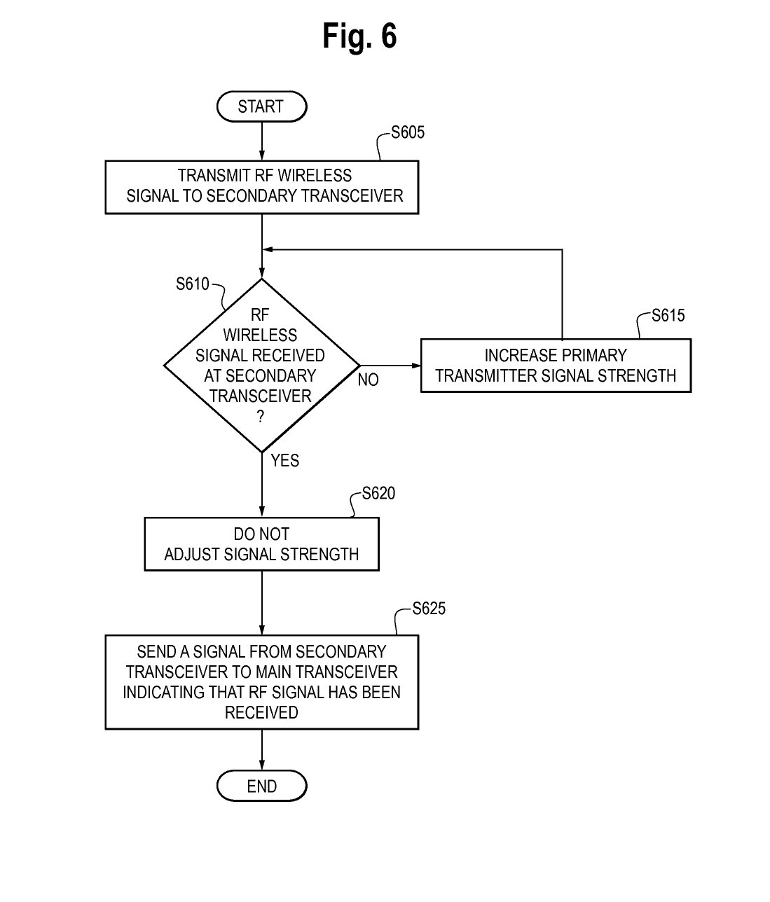

As illustrated in FIGS. 5 and 6, the battery charging feedback system 400 can operate in a variety of ways to ensure that the power supplied by the main transceiver 405 is utilized efficiently. As illustrated in FIG. 5, the process begins and proceeds to S505 where the RF wireless power signal is received at the secondary transceiver 420. The secondary transceiver 420 can then detect the strength of the received signal S510 and communicate information indicating a strength of the signal back to the main transceiver 405. Once the signal is received by the main transceiver 405, it can be determined whether the signal strength is above a predetermined threshold S520, and thus whether the signal strength of the primary transmitter needs to be increased S525 by the power adjusting circuit in order to efficiently transmit the RF wireless power signal.

Using the method of FIG. 5, the battery charging feedback system 400 can efficiently transmit power signals to the battery 410, and the secondary transceivers 420 can relay information relating to the strength of the received signal back to the main transceiver 405 to adjust the transmitted power level so that excessive or inadequate power quantities are not transmitted via the RF wireless signals.

In yet another embodiment, a wireless charging feedback system is shown in FIG. 6 where the power adjusting circuit 425 increases signal strength in the absence of secondary transceivers 420 communicating back to the main transceiver 405. In this manner, if the main transceiver 405 does not receive a signal indicating that the RF wireless power signal has been successfully transmitted to the secondary transceiver 420, the main transceiver 405 knows that the signal strength is inadequate.

In particular, the process begins and proceeds to S605 where the RF wireless signal is transmitted from the main transceiver 405 to the batteries 410 and towards the secondary transceiver 420. At step S610, it is determined whether the RF wireless signal has been received by the secondary transceiver 420 to determine whether the signal strength needs to be adjusted. If the secondary transceiver 420 does not provide a “signal received” signal within a predetermined amount of time, the main transmitter 405 will determine that the power of the RF wireless power signal is insufficient and that the power adjusting circuit 425 should increase the power of the primary transmitter, as shown in S615. However, if the signal has been received by the secondary transceiver 420, the process proceeds to S620, and the signal is not increased. Optionally, the secondary transceiver 420 can then transmit a signal to the main transceiver 405 that the RF signal has been received S625 at the adjusted power level.

The methods referenced above with respect to FIGS. 5 and 6 discuss the main transceiver 405 and the secondary transceivers 420 as transceivers that communicate information relating to the power level of the RF wireless signal. However, the main transceiver 405 and the secondary transceiver 420 can communicate other information, for example, information relating to a cell, temperature, current, capacity, voltage, time, serial number, model number, or other battery charging or management parameters and component number of the battery that is being charged. Additionally, it is possible to place the wireless transceiver circuitry that exists in the second transceiver 420 in each of the battery packs 410 themselves. In this arrangement, the battery packs themselves can communicate directly to the main transmitter, or any host, information relating to a charging status, cell, temperature, current, capacity, voltage, time, serial number, model number, or other battery charging or management parameters and component number of the batter that is being charged, as well as other information. Other information can be communicated between the main transceiver 405, secondary transceiver 420, and battery charging device 110, as needed.

As discussed above, the battery charging device 110 can be either attached to or integral with the battery 120 to which it supplies power. Further, a single battery charging device 110 can charge multiple batteries, or multiple battery charging devices 110 can charge a single battery, as needed.

The above configuration has also been discussed with the battery charging device 110 being dedicated to one battery 120 independent of the container in which it is held, and with the transmitter 105 being remote from the batteries by a relatively large distance. However, the transmitter 105 can be provided in a reusable storage box to charge batteries within the box. Alternatively, the transmitter 105 can rest on a table or surface, or under a table or surface, and send a power signal across the table top or drawer to charge battery packs lying elsewhere. Alternatively, the transmitter 105 can be fixed to a single position, or movable about a position, within a warehouse or another facility that stores electronic devices with batteries.

The matter set forth in the foregoing description and accompanying drawings and examples is offered by way of illustration only and not as a limitation. More particular embodiments have been shown and described, and it will be apparent to those skilled in the art that changes and modifications may be made without departing from the broader aspects of Applicant's contribution. The actual scope of the protection sought is intended to be defined in the following claims when viewed in their proper prospective based on the prior art.

What is claimed is:

1. A battery charging system, comprising:
a transmitter that transmits a radio frequency (RF) wireless power signal at an RFID frequency;
a battery charging device in wireless communication with the transmitter and including,
a receiver adapted to receive the RF wireless power signal; and
a battery receiving portion including a positive and negative terminal adapted to electrically communicate a charge from the RFID frequency to the battery to charge the battery.

2. The battery charging system of claim 1, wherein the battery charging device further comprises a rectifier circuit electrically connecting the receiver and adapted to convert the RF wireless power signal from an alternating current signal to a direct current signal.

3. The battery charging system of claim 1, further comprising:
a secondary transceiver adapted to wirelessly communicate with the transmitter, the secondary transceiver adapted to:
receive the RF wireless power signal from the transmitter and detect a received signal level of the RF wireless power signal; and
communicate the received signal level to the transmitter,
wherein the transmitter further comprises a transmitter receiver adapted to receive the received signal level; and
a power adjusting circuit in functional communication with the transmitter receiver and adapted to adjust a power quantity of a RF wireless power signal to be transmitted based on the received signal level communicated by the transmitter.

4. The battery charging system of claim 1, further comprising:
a secondary transceiver adapted to:
wirelessly communicate with the transmitter;
receive the RF wireless power signal from the transmitter and detect whether the RF wireless power signal has been received; and
communicate to the transmitter a signal indicating whether the RF wireless power signal has been received;
wherein the transmitter further includes,
a transmitter receiver adapted to receive the signal indicating whether the RF wireless power signal has been received; and
a power adjusting circuit in functional communication with the transmitter receiver and adapted to adjust a power quantity of an RF wireless power signal to be transmitted based on the absence of the signal indicating whether the RF wireless power signal has been received.

5. The battery charging system of claim 3, wherein the secondary transceiver comprises a charging circuit adapted to power the secondary transceiver with the RF wireless power signal.

6. The battery charging system of claim 3, wherein the secondary transceivers are one of integral with or attached to the battery.

7. A battery charging method comprising:
receiving an RF wireless signal transmitted at a frequency of about 13.56 MHz;
transmitting the RF wireless power signal to a battery receiving portion; and
charging a battery positioned within the battery receiving portion with the RF wireless signal.

8. The method of claim 7, further comprising:
transmitting the received RF wireless power signal to a rectifier circuit to convert the RF wireless power signal from an alternate current signal to a direct current signal.

9. The method of claim 7, further comprising:
receiving the RF wireless power signal at a secondary transceiver;
detecting a signal level of the RF wireless power signal;
communicating information indicating the received signal level to the main transceiver; and
adjusting a power quantity of an RF wireless power signal to be transmitted based on the received signal level communicated by the main transceiver.

10. The method of claim 7, further comprising:
providing a structure that is adapted to receive the RF wireless power signal at a secondary transceiver;
determining whether the RF wireless power signal has been received;
communicating to a main transceiver the determination of whether the RF wireless power signal has been received; and
adjusting a power quantity of an RF wireless power signal to be transmitted based on the determination of whether the RF wireless power signal has been received.

11. The method of claim 9, further comprising:
sending a signal from the secondary transceiver to the main transceiver that the power quantity of the RF wireless power signal received by the secondary transceiver has been adjusted.

12. The method of claim 9, further comprising:
communicating, between the main transceiver and the secondary transceiver, information regarding at least one of a cell, capacity, temperature, current, voltage, time, serial number, model number, and component number of a battery being charged

13. A battery charging feedback system comprising:
a main transceiver adapted to transmit an RF wireless power signal, the main transceiver further comprising a power adjusting circuit adapted to adjust a power quantity of an RF wireless power signal to be transmitted; and
a secondary transceiver adapted to receive the RF wireless power signal and determine the power quantity of the RF wireless power signal; and
transmit the determined power quantity to the main transceiver.

14. The battery charging feedback system of claim 13, further comprising a battery that is one of integral with or attached to the secondary transceiver.

15. The battery charging feedback system of claim 13, wherein the power adjusting circuit is adapted to adjust the power quantities of the RF wireless power signal to be transmitted based on an absence of a received RF wireless power signal from the main transceiver.

16. The battery charging feedback system of claim 13, wherein the secondary transceiver comprises a powering circuit adapted to power the secondary transceiver with the RF wireless power signal.

17. The battery charging feedback system of claim 13, further comprising:
a battery charging circuit adapted to wirelessly communicate with the main transceiver, the battery charging circuit comprising:
a receiver adapted to receive the RF wireless power signal;
a capacitor in functional communication with the receiver and adapted to hold charge provided by the RF wireless power signal; and
a battery receiving portion comprising a positive and negative terminal and adapted to hold a battery and supply charge thereto.

18. The battery charging feedback system of claim 17, further comprising a rectifier circuit electrically connecting the receiver and the capacitor and adapted to convert the RF wireless power signal from an alternate current signal to a direct current signal.

19. A battery charging device for charging a battery in a battery pack, comprising:
a Radio Frequency (RF) receiving antenna integrated in said battery pack;
a rectifier circuit integrated in said battery pack and configured for rectifying a signal received from said RF receiving antenna and providing a rectified signal; and
a battery connecting portion integrated in said battery pack and including a positive and negative terminal adapted to electrically communicate power from said rectified signal to said battery to charge said battery.

20. The battery charging device for charging a battery in a battery pack of claim 19, wherein said receiving antenna integrated in said battery pack receives a RF signal at a frequency of about 13.56 MHz.
